(19) United States
(12) Patent Application Publication
(10) Pub. No.: US 2010/0033572 A1
(43) Pub. Date: Feb. 11, 2010

(54) Ticket-holder security checkpoint system for deterring terrorist attacks

(76) Inventor: Richard Steven Trela, Clearwater, FL (US)

Correspondence Address: Richard Steven Trela, 100 Pierce Street, #1101, Clearwater, FL, 33756, US

(21) Appl. No.: 11/087,148

(22) Filed: Mar. 24, 2005

Related U.S. Application Data
(60) Provisional application No. 60/555,760, filed on Mar. 24, 2004.

(51) Int. Cl. H04N 7/18; G06F 7/04

(52) U.S. Cl. 348/152; 340/5.8; 348/E07.085

(57) ABSTRACT

A security checkpoint system and apparatus that provides security officers entrusted with protecting our nations' critical infrastructure or other high risk locations, a means of isolating and tracking suspicious persons who enter large public events or public transportation systems. Via a machine, communications system and components that are positioned at entrance points such as stadium section entrances, train station platform entrances, etc., a suspicious person entering the system is processed through a series of onsite as well as off-site follow-up investigations upon first being noticed as suspicious. The machine and it's overt security checkpoint system is designed to induce a suspicious reaction in persons with a guilty mind. As the person registers upon entrance to a facility, a close up view of the persons' face, as well as his seat assignment, is captured by the machine in digital image format. It is then sent by real-time transmission to security personnel in proximity to the location of the machine. A security officer positioned to spot persons manifesting suspicious behavior upon having to register at the machine, highlights the suspicious entrant electronically and sends an e-mail alert along with the digital images of both the suspicious entrant and his ticket, that also displays his seat number or destination, to on-site, as well as offsite law enforcement personnel for further review and investigation as necessary. As the system ties directly into the internet and can be sent to various law enforcement agencies for review, the resulting effect of such broad coverage of review of suspicious persons by law enforcement, makes this invention one of the most effective means of deterring terrorists and criminals in society today.

### CROSS REFERENCE TO RELATED APPLICATIONS

This application is entitled to the benefit of Provisional Patent Application # 60/555,760 Mar. 24, 2004

### STATEMENT REGARDING FEDERALLY SPONSORED RESEARCH AND DEVELOPMENT

NOT APPLICABLE

### BACKGROUND OF THE INVENTION

1. Field of the Invention

The present invention relates to the field of homeland security access control systems. More particularly, the present invention relates to a system and method of providing real-time street level surveillance, as well as digital date and time registration of ticket holders entering high security risk areas, such as V.I.P. areas of stadiums, trains, cruise ships or other events requiring ticket entry. The present invention provides a means of protecting entry into high risk areas against terrorist attacks by use of a system and apparatus that is calculated to invoke suspicious reactions by users who may have something to hide, or who are attending the event or entering the train, ship or other location for purposes of infiltration, or to otherwise cause harm. Entrants using the system are digitally photographed at street level, and are required as well to insert their ticket into a ticket camera reader or bar code scanner, for the creation of a single picture match up of the persons' face along with his seat number. The system allows on-site security officers to snap-shot and send a suspicious person registration back to a command center for programming the person and his seat number, for further investigation review during the event. The system also enables the person and his seat assignment to be transmitted via the internet to off-site law enforcement agencies for a cross-reference check against terrorist watch lists.

2. Background of the Invention

After the terrorist attacks of September 11th, facilities of all types have had to increase security to prevent infiltration or further terrorist attacks. Security officers at locations such as stadiums and trains stations are acutely aware of the need to screen and to keep an eye out for suspicious activity by persons entering such high risk areas. Problems that security officers encounter in trying to be diligent in security operations in today's high risk environment are even more pronounced today than ever. Large crowds and large flows of foot traffic entering stadiums or trains make it very difficult to spot suspicious activities, and even in something suspicious does occur, keeping track of the suspicious person can be very difficult when you consider the large crowds that many events host in today's modern age. It is not unusual at all, for a stadium or train terminal to process hundreds of attendees per hour upon entry into stadiums or public transportation systems. Tactics used by terrorists include entering a facility or train as a ticket-holder to gain access by blending in with the crowd to escape notice. Accordingly, systems for spotting suspicious behavior and assisting security personnel to easily spot suspicious activity in persons entering stadiums and other public venues are very much needed in today's day and age . Terrorism determent at large public gather places and transportation centers has become not only a high priority in the U.S., but globally as well. Prior art references will be found to be limited as the present invention was born out of the need created in the U.S. after the September 11^{th} attacks, for more stringent emphasis on positive access control, and with further emphasis on following up on suspicious behavior in large crows.

### SUPPORTING DOCUMENTATION OF NEED

### Feb. 28, 2005—Heightened Security Awareness

The recent terrorist attack in Tel Aviv highlights the need for everyone to exercise extreme caution and vigilance during their daily routines. The Department of State continues to receive credible information suggesting that extremist groups and individuals are continuing to plan terrorist actions against U.S. interests worldwide. These actions can take place virtually anywhere and at any time and may include suicide bombings, assassinations, kidnappings, or bombings. American Citizens should note that terrorists do not distinguish between official and civilian targets. Terrorists may strike facilities where Americans and other foreigners congregate or visit, such as residential areas, clubs, restaurants, places of worship, schools, hotels, outdoor recreation events or resorts and beaches. American citizens should increase their security awareness levels at such locations, avoid them, or switch to locations where large numbers generally do not congregate.

### FBI Alert On Stadiums

The FBI has issued a “very vague” alert warning that people with suspected ties to terrorist groups have used the Internet to access information on stadiums in the United States and Europe.

FBI officials say images of the RCA Dome in Indianapolis and the Edward Jones Dome in St. Louis were downloaded from WorldStadiums.com, a Web site with information about sports venues around the world.

“There's no specific threat,” said Bill Eubanks, head of the FBI's St. Louis office. “They just simply accessed the Web site.”

“The worst thing we can do is buckle under terrorism. That's what (terrorists) want us to do, thinking they can disrupt our lives,” said Eubanks. “But certainly we should have caution and awareness.”

The FBI issued an intelligence bulletin to law enforcement agencies nationwide in recent days. The agency said it has contacted authorities in both places about security precautions.

World events are daily reminders to all of us to remain alert for suspicious activity at all public venues.

### SUMMARY OF THE INVENTION

The present Invention describes a system, method and apparatus for street level, real-time ticket-holder registration and seat identification of entrants entering a facility that enables security personnel to remain alert and aware of suspicious persons entering stadiums or other public venues. The present invention also by design and strategic placement at entrances to high risk public locations allows a close up review of entrants as well as enables a suspicious entrant to a facility to be registered digitally for later review during the event or public transportation trip. The present invention further describes a sequence of steps the ticket holder must follow which are calculated to trigger suspicious reactions and responses from the entrant with a guilty mind, that are easily noted by security personnel. Noted suspicious reactions then prompts further screening of the suspicious person entering a facility via terrorist watch list comparisons and a programming of person for later review by noting his seat number before he gets lost in the crowds of an event.

In a preferred embodiment, the present invention describes a machine equipped with a street level camera for taking real-time digital video images of a person entering a stadium or other public venue while at the same time the persons' ticket and seat number are scanned and captured in real-time digital video format by a second, strategically placed camera or bar code scanner in positioned in the registration machine housing. The images of both the person and his ticket seat assignment number are simultaneously transmitted either by wire, the Internet or other wireless means from the machine located strategically in front of high risk locations and are connected up with a command center or substation which programs suspicious persons to be matched up against a terrorist watch list, or for further review by roaming security officers during the event. At the review office or center, the image is viewed on a video monitor by a security officer who can separate digitally, suspicious persons entering the facility and match up his seat assignment, should the person come up positive against a terrorist watch list description or picture.

The digitally generated images of both the persons face and his seat number are then made available for review by off-site security personnel and law enforcement agencies via a secured internet connection and website designed for the real-time review and verification of the person entering the event facility.

In addition, the machine can be battery operated and solar re-generated for use in areas not easily provided with electricity, but where it is still very vital to screen and follow up on entrants who may act or appear suspicious upon entry. The unit being equipped for wireless use, can be strategically placed well away from the actual event entrance which can be a strong deterrent to suicide bombers who may try to reach an entrance with a large crowd to effect an attack. This creates a scenario wherein a terrorist wearing a suicide bomber belt would quite possibly abort his mission as his chances of being nullified before reaching his intended target are greatly increased. Further, being equipped so as to be portable, the present invention can be easily set-up for temporary use such as may be needed for special outdoor events such as parades and state fairs. Furthermore, the present invention can be equipped with metal detectors as well as with chemical and biological detectors designed to detect harmful substances on persons upon before entering the event and with additional circuitry and transmitters alert security personnel accordingly.

### ADVANTAGES OF THE INVENTION

The overwhelming immediate acceptance by law enforcement agencies of the current invention has validated the fact that there has been a strong, long felt need for an efficient and convenient method to admit persons entering into high risk locations, and sift out and digitally register persons who look and act suspicious, without targeting the whole general public as suspicious.

The current invention provides many new and unique advantages for law enforcement officials over earlier entrance screening procedures that were as varied as each location, and, which were only as good as the observation capabilities and training of the personnel doing the inspecting. A vast majority of our nations' security checkpoints are vulnerable to penetration by terrorists on many levels. Many weaknesses exist currently at our nations' security checkpoints that the current invention helps to remedy. With the fact that human confront capabilities of terrorists and criminals varies widely between security individuals, “look the other way” tendencies are prevalent. This, along with countless other problems related to large public entry screening are directly assisted by proper use of the present invention. The present invention describes a vital new, efficient system of entrant screening that allows suspicious activities to be easily spotted no matter persons are entering into a stadium or other public venues. Indeed, as will be seen in the following pages this invention creates many new and effective security procedures that can easily be utilized by security personnel who must confront today's terrorism risks on a daily basis.

Another advantage that the present invention inherently provides, is the ability to quickly train security personnel on procedures that drill and enhance observation skills on so that they can be more alert to suspicious reactions from persons using the described invention at a facility entrance in real-life. Another advantage to the system is that descriptive skills vary amongst security personnel and since the system is designed to communicate visual images for immediate review by other on an off-site personnel, language barriers are minimized by the use of a visual identification process. An additional advantage of the present invention is that weather problems such as wind blown sand, rain extreme cold, or other environmental factors that may inhibit proper entrant screening can now be reviewed from the comfort of a command center a distance away and out of the weather. The events of September 11^{th} have also created the unforeseen need for insurance companies insuring against terrorism or assassinations to be able to document security diligence in preventing terrorist attacks or an assassination. The present invention answers this problem by providing a real-time observation of entrants entering high risk public locations and providing, through digital image electronic storage, a large digital library of preformed checkpoint screening actions by date and time for each event. Also provided is an earmarked list with pictures and seat numbers, of suspicious persons who have been programmed for review during the event. After the event, the insurance company is given a complete digital logs of the real-time entrant verification process of persons entering high risk areas should they be necessary or can be given to law enforcement officials for detailed review against National and International watch lists.

### BRIEF DESCRIPTION OF THE DRAWINGS

The present invention will be understood and appreciated more fully from the following description, taken in conjunction with the drawings in which:

FIG. 1 is a block diagram illustrating the typical layout and foot traffic scenarios of entrants to a large event or public transportation system.

FIG. 2 is a block diagram illustrating the foot traffic flow entering a facility according to the present invention.

FIG. 3 is a block diagram illustrating the present inventions' sequence of actions an entrant goes through in a real-time ticket and entrant verification process.

FIG. 4 is a flow chart illustrating further the sequence of steps a ticket holder goes through in a real-time use and in a preferred embodiment of the present invention;

FIG. 5 is a diagram which illustrates a suspicious person going through a real-time ticket registration process.

FIG. 6 is a diagram which illustrates a suspicious person further involved in the ticket registration process.

FIG. 7 is a diagram which illustrates the processing of the suspicious reactions to other security personnel on and off site.

FIG. 8 is a diagram which illustrates further follow up actions to the suspicious person being noted.

FIG. 9 is a diagram illustrating watch list matching to the suspicious person registration over the internet.

FIG. 10 is a diagram which illustrates a security officer responding to a watch list match up in real-time out in the stadium seating area.

FIG. 11 shows the interconnectivity and the component functions of the entire system

FIG. 12 shows the interconnectivity and the component functions using computer based optical motion detection registration of the entrant and his ticket and seat assignment.

FIG. 13 shows the system equipped for biological, chemical and metal detection as well as being equipped with an alert transmitter that upon detection of hazardous materials transmits an alert to a command center communications system.

FIG. 14 shows the ticket registration utilizing a bar code scanner.

### DETAILED DESCRIPTION OF THE PREFERRED EMBODIMENTS

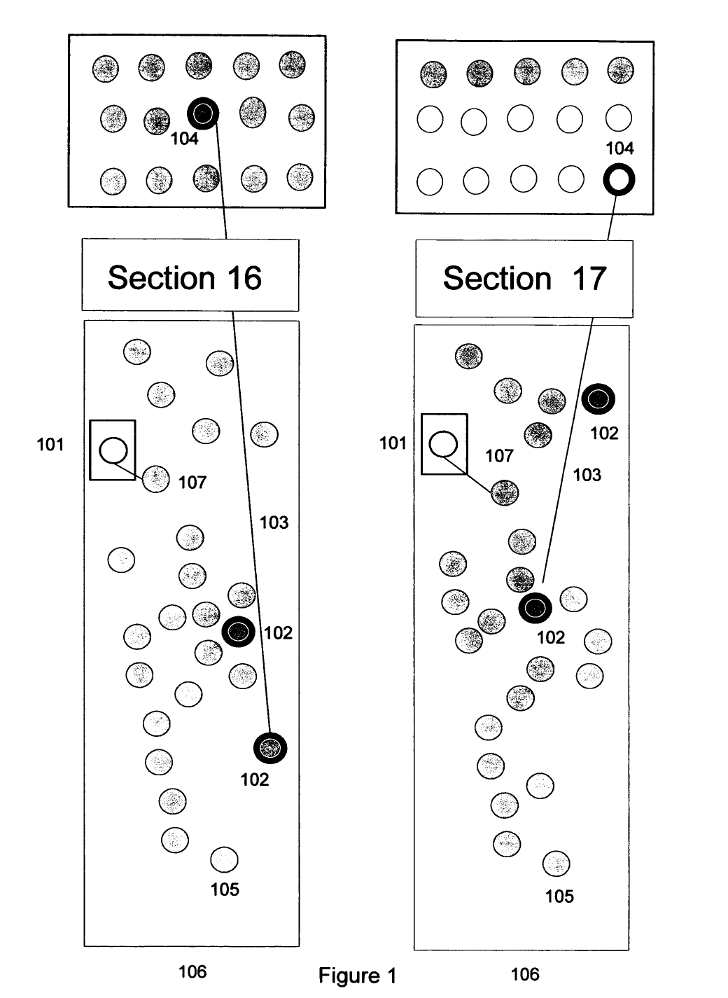

Reference is now made to FIG. 1, which is a diagram illustrating the typical sequence of a entrants attending an event progress through getting to their assigned seats. As shown, an entrant 105 typically walks through an entrance tunnel or 106 gate and passes by a security officer 101 who checks zones on tickets 107 for correct seat areas for attendees or checks randomly 107 attendees for proper seating passes upon entry to a stadium section 108. The diagram further illustrates how a suspicious person or terrorist 102 can work his way past 103, the security person 101 by blending in with the crowd. Through this set of circumstances the suspicious person or terrorist 102 ends up in the stands 104 without further notice.

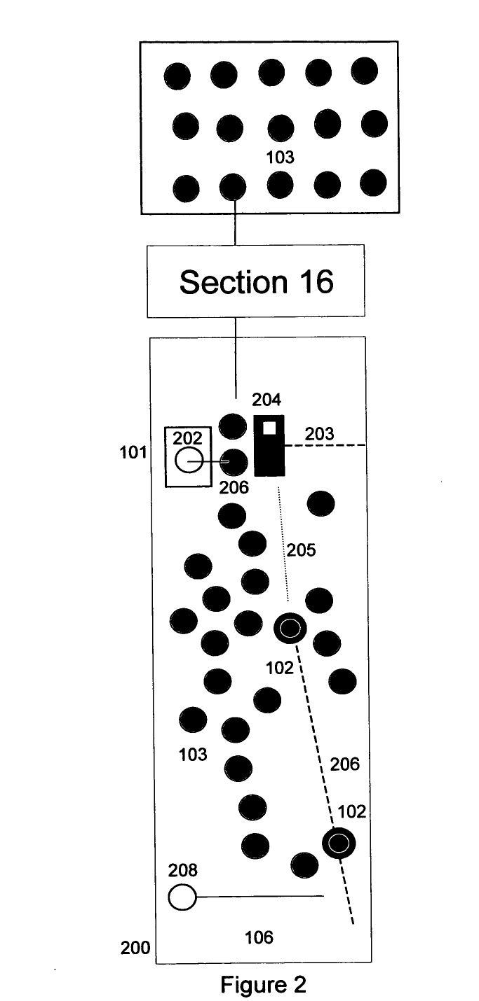

Reference is now made to FIG. 2 which is a block diagram illustrating the foot flow entering an event according to the present invention 200, wherein, the ticket registration machine 204 is placed in the traffic flow line and traffic is channel by barrier 203 so the traffic flows past the machine through a path created between the security officer 101 and the ticket registration machine 204. The security officer 101 is shown having his full attention on the entrants to the section who use the machine 206 as they pass through to the seating area to be seated 103. The illustration further shows suspicious person 102 spotting the security procedure ahead 205 with the machine 204 and the security officer 101 who has his full attention on each entrant using the machine 206 and departs the line 102 and exits the tunnel 106. Upon exiting the tunnel 107 a security officer 208 takes note of the exiting of suspicious person 102 for follow up.

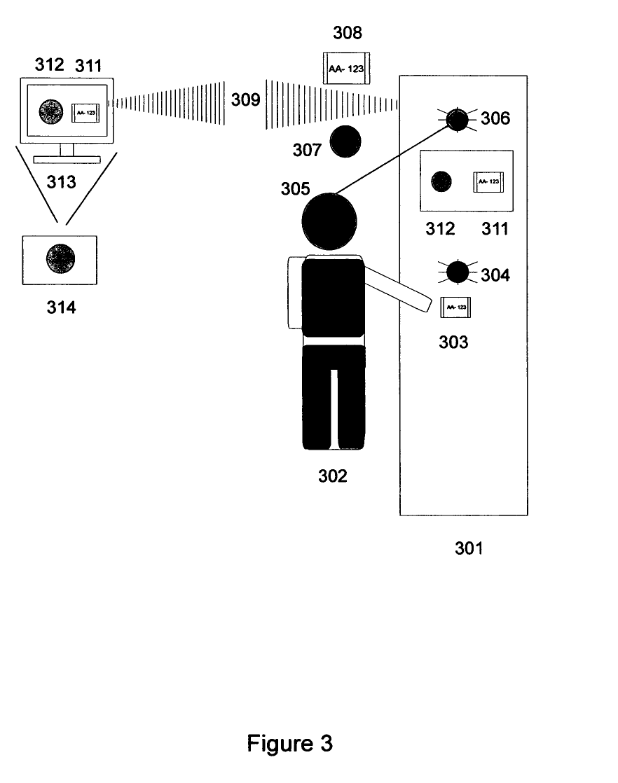

Reference is now made to FIG. 3 which is a diagram illustrating the sequence of actions a ticket-holder goes through in the real-time ticket registration. The entrant 302 first stands in front of the ticket registration machine 301 in direct line of sight of the registrant digital camera 306 (a typical bullet CCD low voltage mini camera) which takes a picture of the entrants 302 face as he enters the facility entrance. At the same time the entrant 302 raises his ticket for a picture to be taken of his seat number 303 by digital camera 304 (a typical bullet CCD low voltage mini camera) which then is sent wirelessly 309 to viewing monitor 313 at the security officers station. The digital image of his eat number 308 and the digital image if the entrant 307 appear via the wireless transmission 309 as the entrants image 312 and his seat number 311.

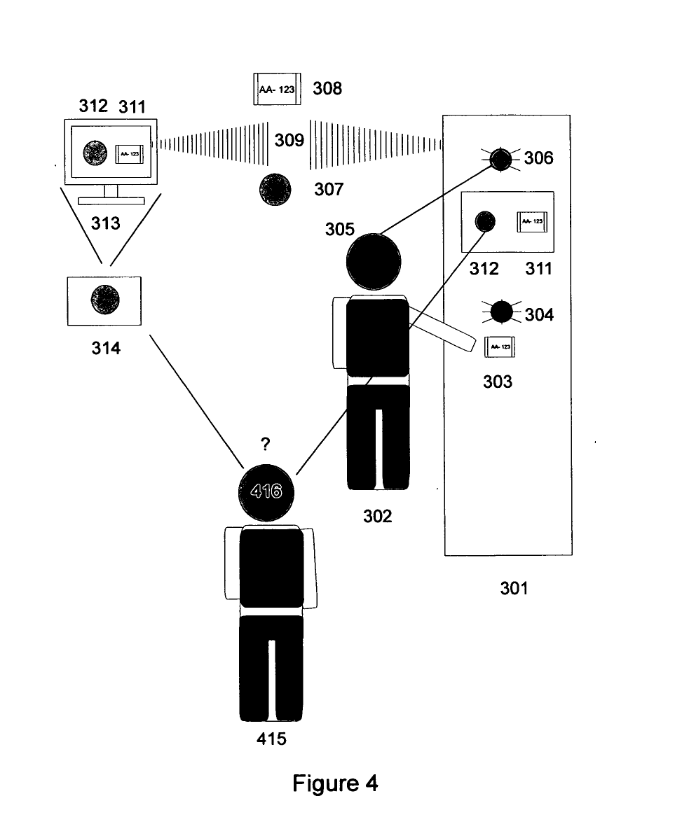

Reference is now made to FIG. 4 which is an extension of the FIG. 3 block diagram that further illustrates the present inventions' use in real-time. The new suspicious entrant 415 manifests uncertainty 416 upon the approach to machine 301. His attention is drawn to the entrants image being taken by camera 306 and to receipt of that image appearing at monitor 313 and being viewed by security officer 314.

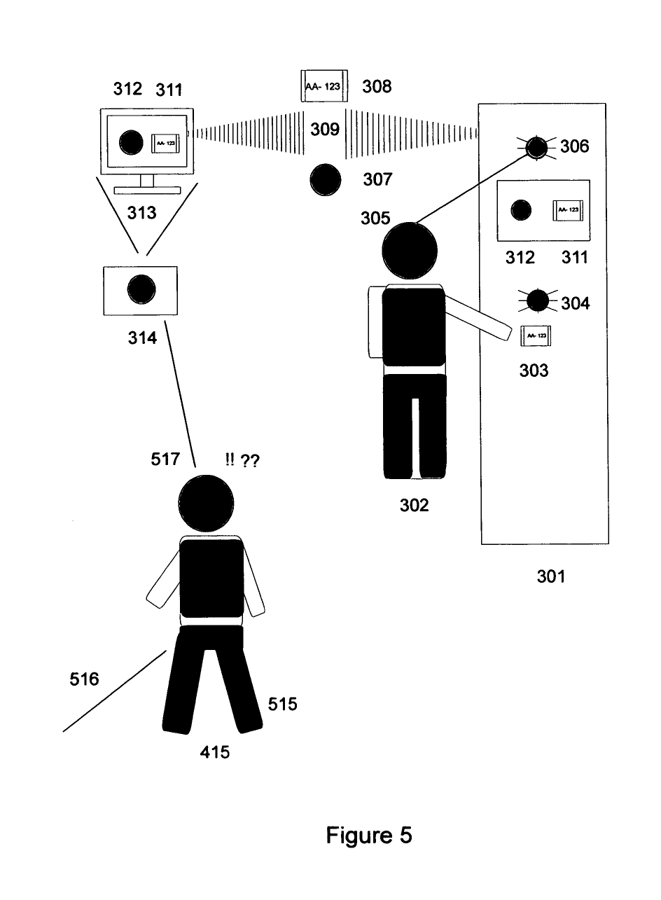

Reference is now made to FIG. 5 which illustrates the suspicious entrant 415 now walking away from the entrance 515 towards an exit 516 while wondering whether he has been noticed 517 by security officer 314.

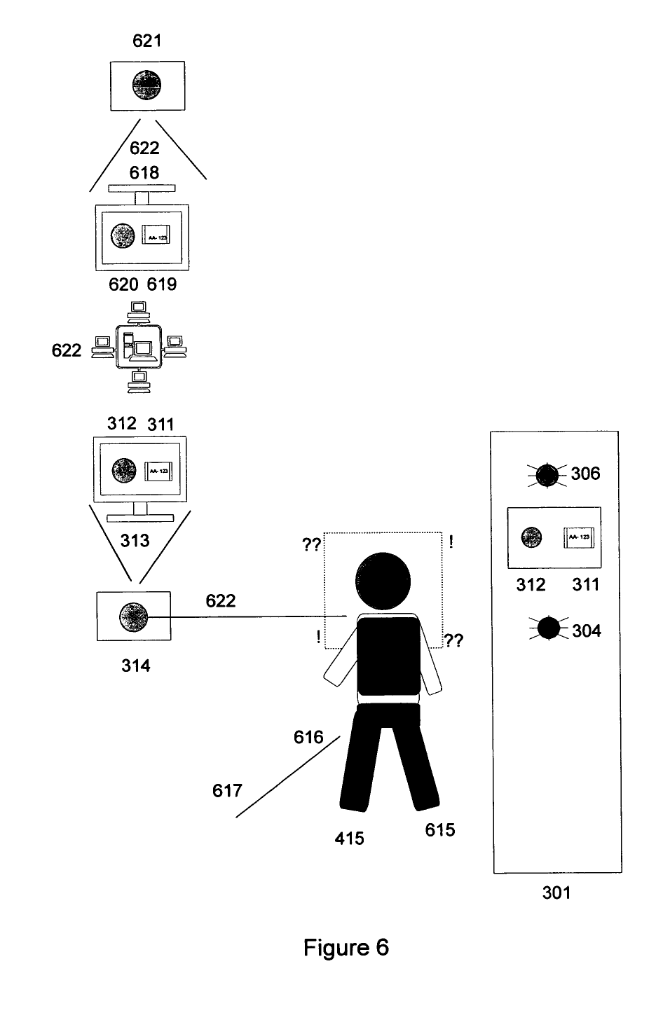

Reference is now made to FIG. 6 which illustrates a variation of the scenario in FIG. 5 wherein the suspicious entrant 415 realizing security officer 314 has seen him 622 and that wonder 618 whether his indecision to leave 617 or now stay 616 is manifested by his pause 615 or other type of suspicious behavior such as looking away, looking worried, being in an unnecessary hurry 623, etc.

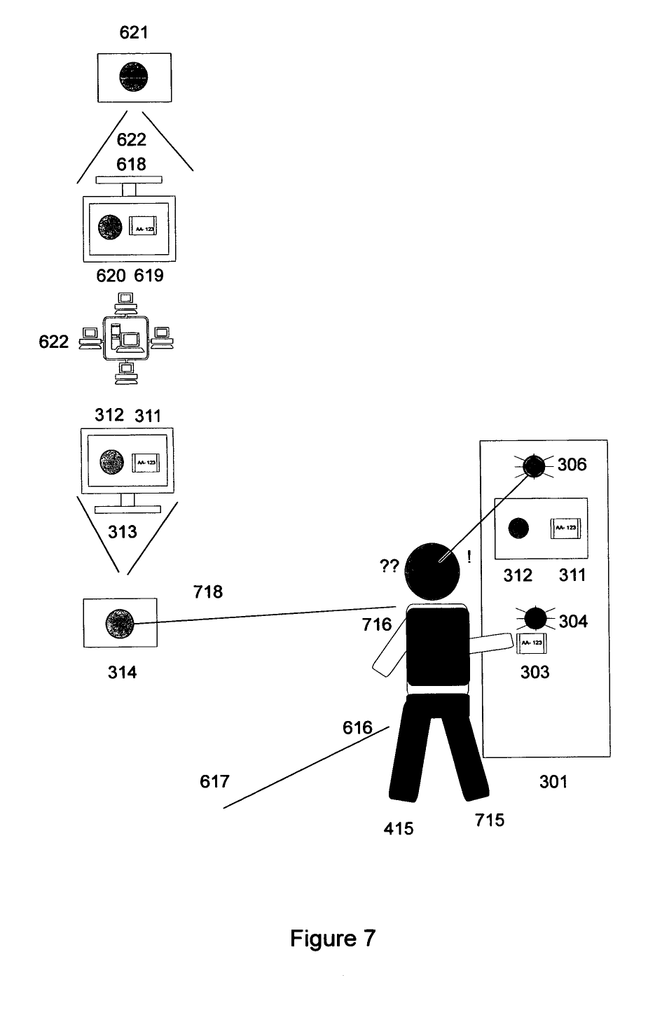

Reference is now made to FIG. 7 which illustrates an extension of progress of the suspicious entrant 415 wherein he proceeds 715 through the process by standing in front of the machine and having his picture taken 717 by camera 306 while still showing concern 716 that security guard 314 is watching him. FIG. 7 also shows the suspicious entrant 415 having his ticket and seat number scanned 303 by camera 304 and then being wirelessly sent 309, 308, 307, to monitor 313 for recording and review by security officer 314 and by offsite security officer 621 via the internet 622.

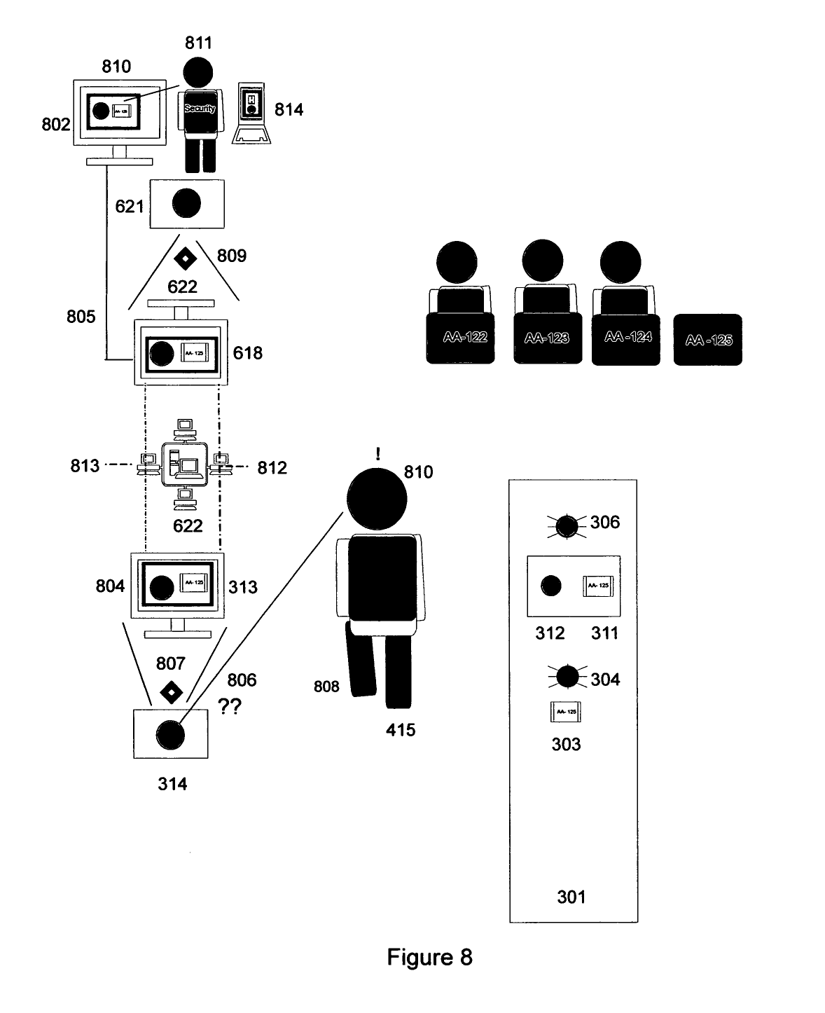

Reference is now made to FIG. 8 which illustrates how the security officer 314 notes the suspicious entrant 415 walking past him 808 and acting suspiciously 810 after having registered at machine 301. The security officer 314 then sends 807 a picture of the suspicious entrant and his seat number 804 via e-mail 812 or through a real-time web-server connection 813 to security officer 621 via the internet 622. Security occur 621 then forwards the email or an e-mail alert to roaming security officer 811 who receives his instructions to further investigate suspicious person 415 via a computer terminal 810 or a PDA 814.

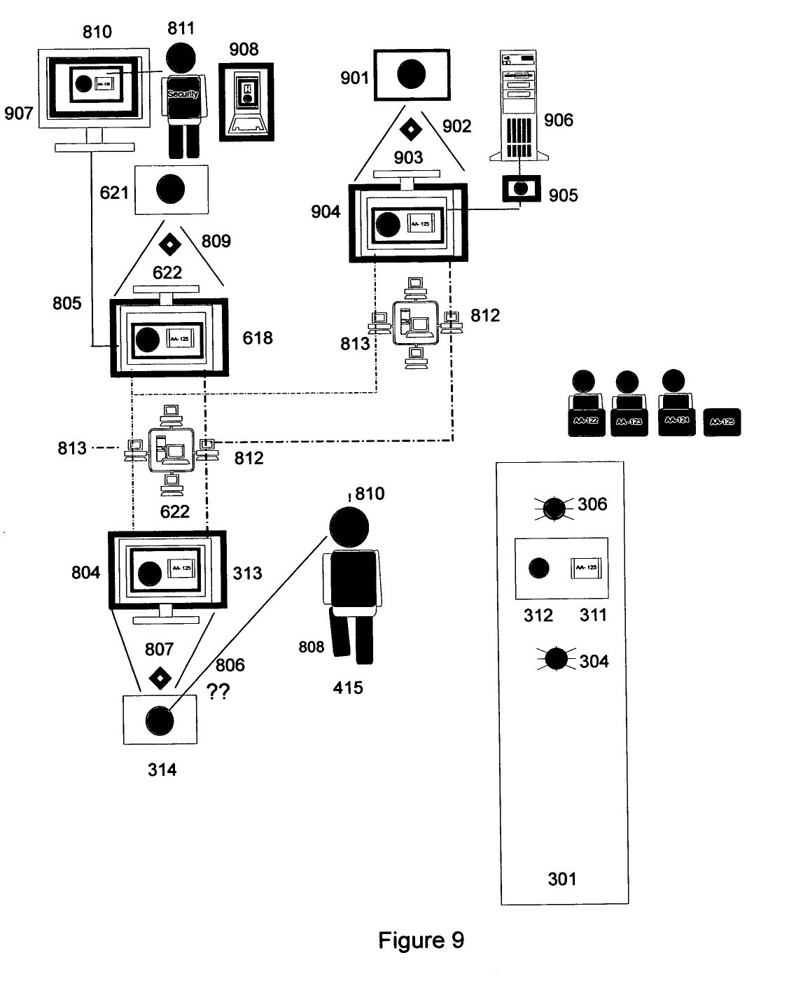

Reference is now made to FIG. 9 which shows an offsite law enforcement officer 901 monitoring suspicious persons alerts on the internet 812 and by emails 813 originated by security officer 314 and performing a search of suspicious person 415 against his national watch-list data base in computer 906 who gets a positive match against a known terrorist or criminal 905 which is seen by him 902 on as a match 904 on viewing screen 903. Law enforcement officer 901. Law enforcement officer 901 then triggers an urgent e-mail alert to security officers 621 and 811 who receive an urgent message on either screen 907, 313 or PDA 908 which indicates suspicious person 415 is in need of further investigation.

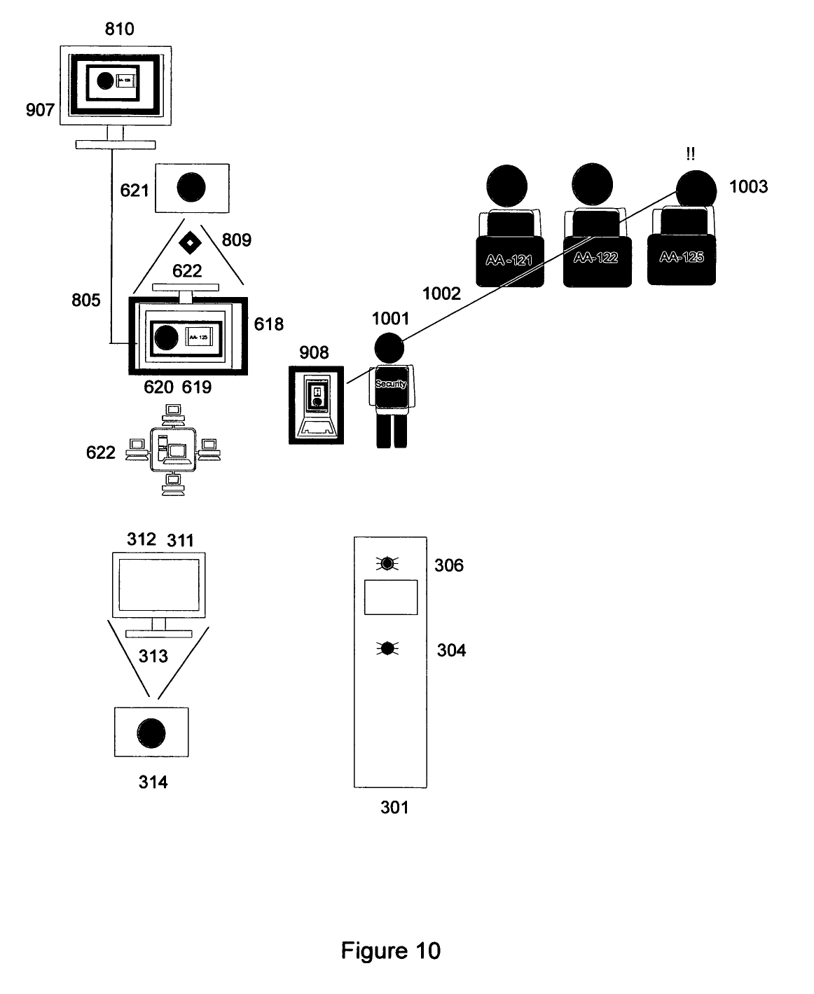

Reference is now made to FIG. 10 which shows security officer 1000 on foot patrol with reference to his PDA alert 908 looking for the watch list match reference on his PDA at his assigned seat 1003.

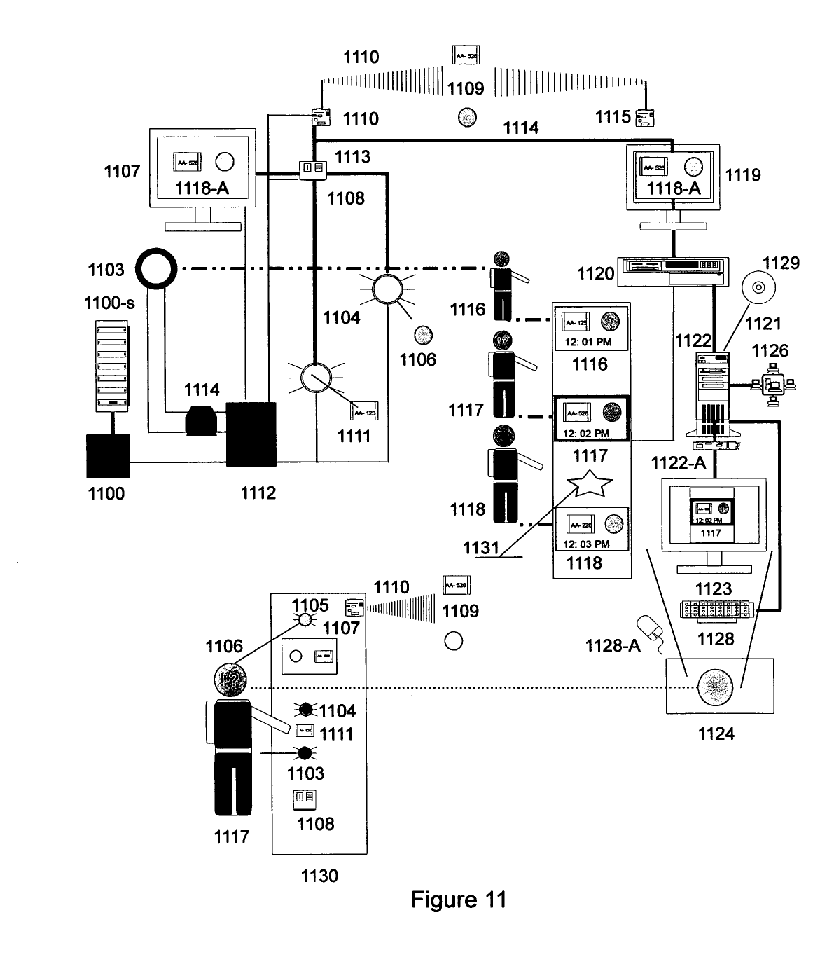

Reference is now made to FIG. 11 shown with a battery powered 1100 and solar regenerated 1100-s. Power originated at 1100 battery supply is junctioned then distributed to the various low voltage components of the system built into the ticket registration unit housing 1130. When the entrant 1117 places his ticket 1111 in front of camera 1104 to be photographed, his face is now also in a position to be digitally photographed 1106 while in front camera 1105. A simultaneous picture is taken by both cameras 1104 and 1105 at the same time. These images are combined at standard video screen splitter/combiner unit 1108 and made into one single image 1118-A for display on screen 1107 mounted in the ticket registration unit housing 1127.

The image 1118-A is also sent via wireless transmitter (for example HP12-200TX which generally operate between 900 mghz and 5.8 ghz,) across a distance 1109 to a wireless receiver matching receiver 1115 located near the security viewing station, preferably in close proximity to the line of entrants 1116, 1117, 1118 entering the facility. The image 1118-A also shows up on screen 1119. at the security station side of the system. For locations that allows for a hardwire connection, 1114 a hard wire connection, is shown, between the transmitter and receiver sides of the system. From the receiving side of the system, the transmitted image via either 1114 or 1109 is directly sent into a standard security DVR (digital video recorder) equipped to record events in sequence, demark them and then, automatically title, new files on each video event entry by date and time. As each entrant to a facility 1116, 1117, 1118 triggers a new video event 1116-A, 1117 A, 1118 A, upon activation of sensor 1103, a new security event is recorded and logged into the DVR 1120 hard drive. The DVR 1120 records separate events as each new person triggers a video event, and creates a new digital file slot ready for the next entrant when the video image is interrupted 1131 between each entrants' ticket registration. The video events of each entrant and his ticket are also sent directly into CPU 1122 equipped with a digital video card 1122-A (Geo-vision 600 or equivalent). As well as providing full event recording of all entrants to a facility, the CPU allows full internet and e-mail capability for sending suspicious person information. This ability is shown being accomplished via security officer 1124. When security officer 1124 notices suspicious person 1117 he activates a screen capture process via a mouse 1128-A and keyboard 1128 and standard screen capture 1129 software to capture and then send an e-mail 1125 via the internet 1126 to offsite law enforcement personnel for watch list comparison. The e-mailing capability can be accomplished directly as well, by initiating a “snap-shot” of the images sent into the system via the video capture card 1122. Also shown is security officer 1124 sending an e-mail to roaming security guards FIG. 10 1001 on the premises, in charge of the seat section of the suspicious person.

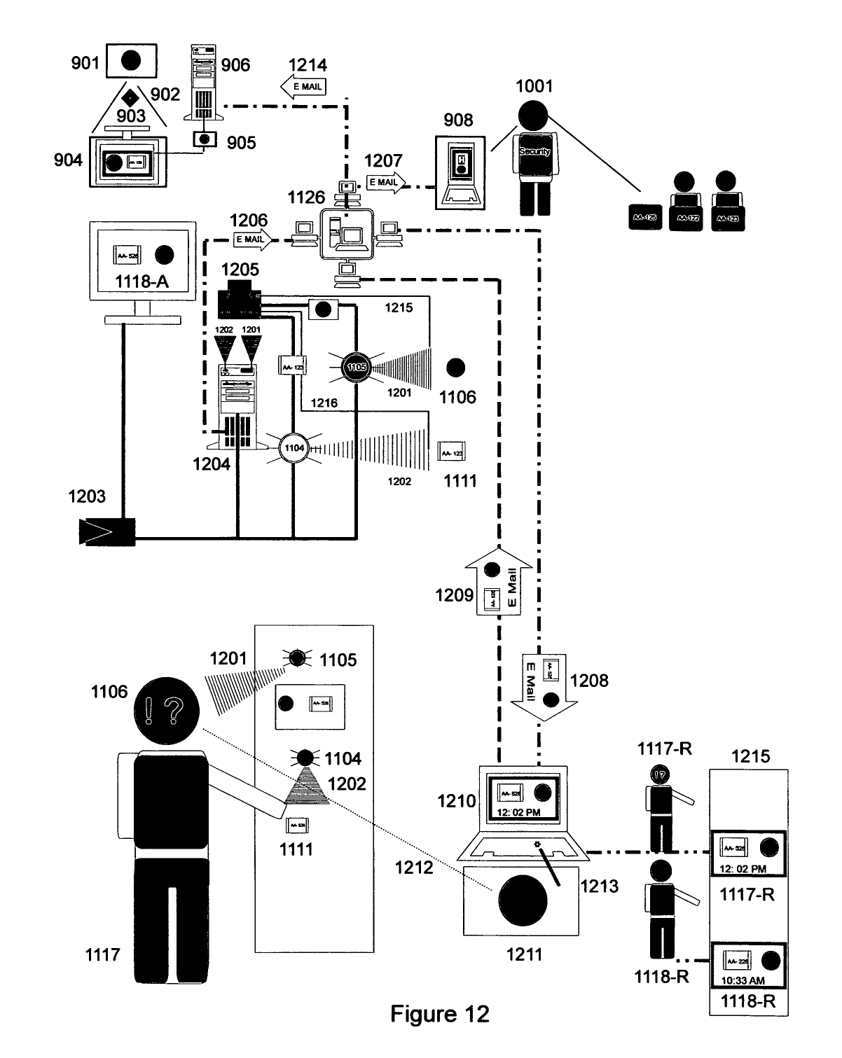

Reference is now made to FIG. 12 that shows a component configuration and system working to create the images of the person and his seat assignment via a computer 1204 equipped with a video capture card (Geo-vision 600 or equivalent) with the motion detection feature enabled 1216 in the ticket camera 1104 as well as the motion detection feature enabled in 1215 for the ticket-holder camera 1105. Optical motion detection field 1201 activates an e-mail snapshot of the ticket holder 1117 when he is in front of the camera 1105 and optical motion detection field 1202 activates an e-mail snapshot of the ticket and seat assignment 1111 and sends them both 1117 and 1111 via an e-mail event 1206 through the internet 1126 to security officer 1211. Security officer 1211 upon noticing suspicious actions 1212 by the entrant 1117 forwards 1213 the snapshots (in JPEG or other picture form) to the necessary e-mail recipients, law enforcement officer 901 via e-mail package 1214, roaming security officer 1001 via email package 1207 and as well as the command station e-mail log 1215 which stores registered suspicious persons 1117-R and 1118-R for further reference during the event.

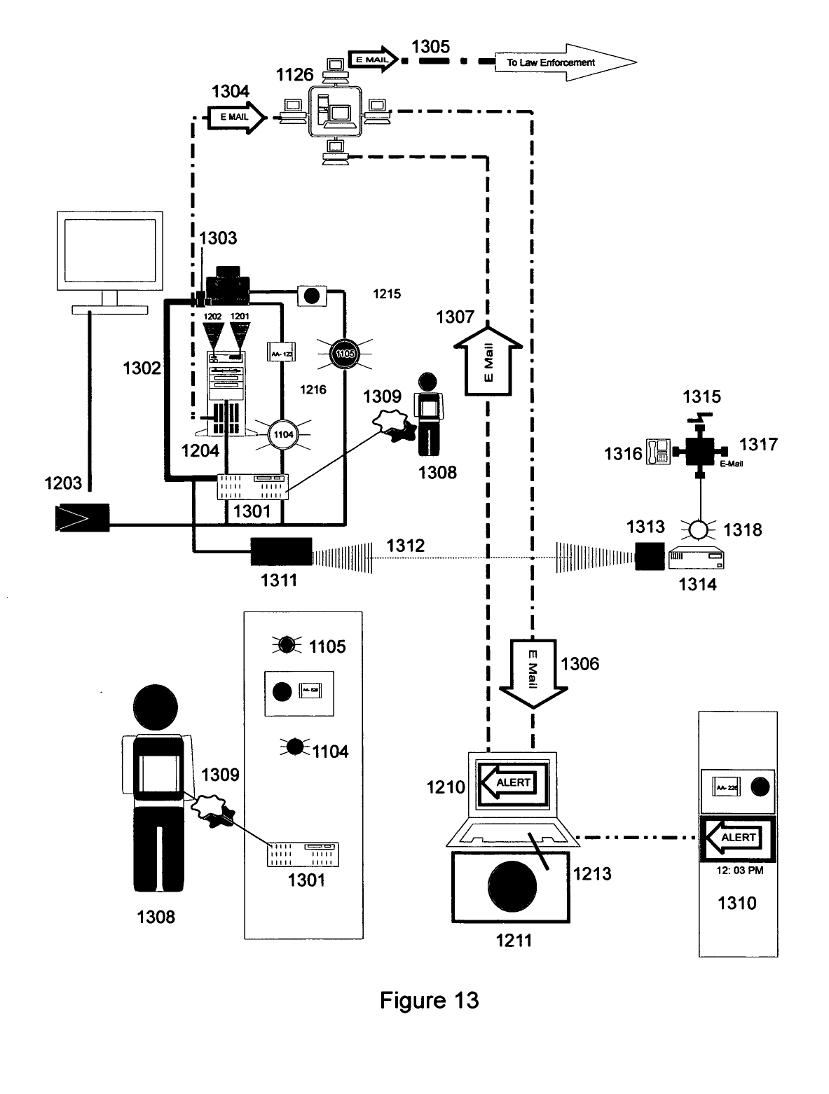

Reference is now made to FIG. 13 which shows the system equipped for biological, chemical and metal detection 1301. Power is supplied to the biological, chemical and metal detection panel 1301 by power supply 1203. Detection of harmful agents 1309 by a person entering the facility 1308 triggers a relay via wire 1302 to the I/O e-mail relay input 1303 on video card 1205. An alert e-mail 1304 pre-programmed into computer 1204, and triggered by I/O input relay 1303, is sent via the internet 1126 to predetermined law enforcement recipients 1305 as well as to the command station, via alert 1306 that automatically registers the alert in harmful agent alert log 1310. A transmitter 1311 which is a standard extended range transmitter (XT-1 Linear) that is transmitted to 1312 and received by it's matching receiver (XT-1 Receiver Linear) 1313 which activates an automatic communication CPU or programmable emergency communications unit 1314 designed to initiate preset 1316 phone calls, pager alerts 1315 or e-mail alerts 1317 as well as trigger an alert at a local alert box 11318 that sounds an alarm when a detection is originated from detector 1301.

FIGS. 11, 12 and 13 show the entire system, component structure and component variations, including a suggested housing, that would enable a person skilled in the art, to make and use the invention without extensive experimentation.

While the present invention has been described with reference to the preferred embodiments, those skilled in the art will recognize that numerous variations and modifications may be made without departing from the scope of the present invention. Accordingly, it should be clearly understood that the embodiments of the invention described above are not intended as limitations on the scope of the invention, which is defined only by the following claims.

1. A digital video and computer-based ticket registration and security checkpoint machine and system for deterring criminals and terrorists by initiating a process and system of security checkpoint steps a suspicious entrant entering a facility or public mode of transportation follows that registers a suspicious entrants' picture identity along with his ticket seat assignment electronically upon entrance to a facility comprising and in accordance with drawing FIGS. 1-13 and further comprising;
a machine housing that serves as a base station for the gathering and simultaneous transmission of real-time digital video images of both an suspicious entrant to a facility as well as ticket and seat assignment;
a digital camera positioned in said machine housing to capture accurate digital video images of a suspicious entrant to a facility;
a digital camera positioned in said housing to capture accurate digital video images of the entrants' ticket and seat assignment upon his entrance to a facility;
a bar code scanner positioned to capture an accurate scan of the entrants' ticket to register his seat assignment electronically against a database upon his entrance to a facility;
a server computer including a processor, digital video card and software for transmitting said digital video images of said bar code scan information of said suspicious entrant and his ticket and seat assignment over the internet by e-mail;
a wireless video transmission system for providing visual information of a suspicious person's facial image as well as his assigned ticket and seat number information to on-site security personnel for recording of said images along with the date and times of suspicious persons entering a facility on a digital video recorder hard drive,
a database for recording storing digital images of the suspicious entrant and his seat assignment along with date and time of entry information of the entrant on a digital video recorder;
an e-mail system for sending JPEG images of a suspicious entrant and his ticket seat along with his seat assignment over the internet;
The system of claim 1, wherein the communications network is the Internet and a local wireless video transmitter and receiver system.

2. A security procedure utilizing the system of claim 1 comprising;
at least one on-site security person positioned so as to be able notice suspicious activity by an entrant entering into the system and using said machine described in claim 1 who e-mails a picture of the said suspicious entrant as well as a picture of said suspicious persons seat assignment to off-site law enforcement personnel for comparison to a terrorist watch list or criminal watch list for a positive match of the suspicious entrant;
at least one on-site security person positioned so as to be able notice suspicious activity by an entrant entering into the system and using said machine described in claim 1 who e-mails a picture of the said suspicious entrant as well as a picture of said suspicious persons seat assignment to on-site law enforcement personnel for further review of the suspicious person after his entrance said facility or transportation system.
on-site law enforcement personnel and roaming security personnel equipped with an e-mail capable machine capable of receiving e-mail photos and text over the internet or via a cellular communication.
off-site law enforcement personnel equipped with an e-mail capable machine capable of receiving e-mail photos and text over the internet or via a cellular communication

3. The system of claim 1 further comprising a housing equipped with biological sensors that can detect harmful biological agents and set off an alarm back at security post located a safe stand-off distance away from assets and people;
further comprising a housing equipped with chemical sensors that can detect harmful chemical agents and set off an alarm back at a security post located a safe stand-off distance away assets and people.
further comprising a housing equipped with metal detector sensors that can detect large amounts of metal indicating a suicide bomber pack or other weapon and set off an alarm back at a security post located a safe stand-off distance away from assets and people.
further comprising at least one of a computer, a cellular telephone, kiosks, a PDA, or other remote computing device linked to the server via the said communications link to verify in real-time the identity of the entrant to the facility.
further comprising at least one of a computer, a cellular telephone, kiosks, a PDA, or other remote computing device linked to the server via the said communications link to receive alerts from biological, chemical or metal detection sensors located in the said housing of claim 1.
